(19) United States
(12) Patent Application Publication
(10) Pub. No.: US 2026/0242181 A1
(43) Pub. Date: Aug. 20, 2026

(54) WHEELCHAIR-ACCESSIBLE ELEVATOR CAR

(71) Applicant: THOMA AUFZUEGE GMBH, FRANKFURT (DE)

(72) Inventor: VOLKER FRITZ

(73) Assignee: THOMA AUFZUEGE GMBH, FRANKFURT (DE)

(21) Appl. No.: 18/859,356

(22) PCT Filed: Apr. 20, 2023
(86) PCT No.: PCT/EP2023/000024

§ 371 Date: Oct. 23, 2024

(30) Foreign Application Priority Data
Apr. 25, 2022 (EP) 22000106.9

(51) Int. Cl. B66B 11/02; B66B 7/02

(52) U.S. Cl. CPC B66B 11/0226; B66B 7/021

(57) ABSTRACT

An elevator car for a passenger elevator having a floor, at least one wall element, an access opening, and a car door, which can close the access opening. The floor extends within a floor area and is delimited by a plurality of edges where four edges are located on the sides of a rectangle and the other edges are located within the rectangle so that the floor forms at least two broad corners in the region of the other edges, namely a first and second broad corners. The car door can be moved in the closing direction from an open position to a closed position and is in the form of a sliding door having first and second leafs. The first leaf has a front edge oriented in the closing direction and an opposite rear edge. The second leaf has a front edge oriented in the closing direction and an opposite rear edge. The first leaf moves beyond the second leaf in the closing direction. The second leaf adjoins the first broad corner when the car door is closed. When the car door is open, at least the rear edge of the first leaf does not lie over the floor of the car but lies within the rectangle.

### FIELD OF THE INVENTION

The present invention relates to an elevator car for a passenger elevator. In particular, the car is to be optimized for use by wheelchair users.

### BACKGROUND OF THE INVENTION

European patent EP 1 591 401 B1 discloses a typical elevator car. This is constructed as a cuboid on a rectangular base. Only a single door is provided at the front. The car is supported by a car frame which surrounds it at both lateral walls. This car frame in turn supports a transverse beam that runs across the car ceiling. Furthermore, rollers and a corresponding roller support beam are provided on the car ceiling. This car construction is certainly appropriate for a typical elevator shaft, but requires a large shaft and, due to the roller drive, is generally dependent on a complex and heavy drive unit above the shaft. Frame elements cannot be used to provide elevator access in these regions. The present invention aims to provide an elevator and a corresponding car which are significantly more compact and can also provide access from several sides.

European patent EP 2 516 314 B1 discloses another elevator car. It discloses a cuboidal car on a rectangular base, which car appears stable due to its rectangular floor frame and the corresponding roof frame. The car doors are guided at the top in a door guide rail and are supported at the bottom by a car door sill. This construction appears to allow the doors to be guided reliably. It is also quite typical of many cars. However, both the door guide rail and the car door sill protrude significantly beyond the car to the left and right (i.e., in the opening direction of the doors). Accordingly, a generously dimensioned elevator shaft is required. Such a solution seems less suitable for retrofitting a disabled elevator. In any case, it requires a lot of space.

The Japanese patent application JP 2006151625 A2 discloses an elevator with a compact guide and drive unit. The elevator comprises a car on a square base. The elevator shaft is also square. Guide elements are provided to the left and right of the car. Further drive and guide elements are provided behind the car. This also includes a counterweight, which is guided on the rear wall of the elevator shaft. Overall, the construction appears space-saving. However, the required shaft dimensions are significantly larger than the car dimensions. Only the front region of the shaft, where access doors are also provided, is free of technical components for the drive and guide. On the rear side, the shaft must be considerably larger than the car, and large clearances must also be provided in the shaft to the sides of the car. The present invention aims not only to offer an elevator that is particularly suitable for wheelchair users, but also to offer an even more compact elevator. This is already taken into account in the car construction.

Elevators, and in particular passenger elevators such as those in the cited prior art, are used in many places to increase convenience and thus typically to avoid climbing stairs. For people with disabilities and wheelchair users in particular, however, it is not about comfort, but about making it possible to overcome heights. In this respect, wheelchair-accessible elevators play a major role and the demand for them is considerable. To a large extent, meeting this demand is also restricted by the limited financial resources available. There is thus an ongoing interest in finding particularly efficient and cost-effective elevator solutions that are highly suitable for wheelchair users.

In this context, it should be borne in mind that rectangular or square elevator shafts are generally used for architectural purposes. However, a rectangular elevator shaft is not particularly advantageous for a wheelchair user. As a rule, wheelchair users should be able to turn about their longitudinal axis, for example to enter in one direction and then exit forwards again in the opposite direction after turning 180 degrees. The greater length of a rectangular elevator car along one axis is of no advantage here. The ease of turning about an axis is determined only by the direction of the shorter extension, while the space provided in the other direction is useless, for example also in the sense that although two wheelchairs may be accommodated one behind the other, their maneuverability would be too limited.

This problem is solved by an elevator car according to claim 1. Advantageous developments are given in the dependent claims. The advantages are also achieved by a passenger elevator according to claim 12 and the associated dependent claims.

An elevator car according to the present invention will have a floor, at least one wall element, an access opening and a car door that can close the access opening. (As a rule, further elements are included).

The floor may comprise an upper floor, which supports a user and is generally walked on by the user, and additional supporting floor elements arranged below it. In the context of the present invention, the floor is intended to encompass the entire area bounded by the outer surfaces of the lateral walls and the car doors.

The elevator car is to be installed in a rectangular shaft and accordingly have wall elements arranged along rectangle edges. The elevator car will have at least one access opening which occupies part of such a rectangle side or even the entire length of such a rectangle side. This access opening should be able to be closed by a car door.

The floor is delimited by a plurality of edges. The geometry of the floor is such that four of the delimiting edges are arranged along a rectangle and the remaining edges are arranged within the rectangle area in such a way that the floor forms at least two broad corners in the region of the remaining edges, namely a first broad corner and a second broad corner. (If door sills are provided on the floor, these count as part of the floor and should therefore lie within the rectangle).

An expedient floor can therefore be defined by six edges, four of which are arranged along the sides of a rectangle and two edges are arranged so that they bridge the corners of the rectangle and are opposite each other.

It can also be expedient if the floor is defined by eight edges, wherein four edges are again arranged along the sides of a rectangle and the remaining edges each bridging the corners of the rectangle. It is expedient here if the four longest of the edges are those arranged on the sides of a rectangle. It is also expedient if, among the remaining edges, the opposite edges are each the same length. It can be expedient if one pair of edges is longer than the other. The longer pair of edges will then form the broad corners, i.e., the first broad corner and the second broad corner.

The car door is intended to move between an open position, in which access to the elevator car is possible, and a closed position. In the closed position, access to the elevator car is blocked. From the open position, the car door moves along a closing direction to close. As a rule, the car is closed by a lateral movement in the closing direction. The car door is to be formed as a sliding door with a first leaf and a second leaf. The first leaf should be the “fast” leaf. This means that the first leaf will move beyond the second leaf in the closing direction. The first leaf should have a front edge oriented in the closing direction and an opposite rear edge, the second leaf should also have a front edge oriented in the closing direction and an opposite rear edge. The second leaf should be adjacent to the first broad corner when the car door is closed.

According to the present invention, at least the rear edge of the first leaf should not be over the floor of the elevator car when the car is open. This means that the space outside the elevator car is also used for the movement of at least one of the leaves of the car door.

It is also expedient if the rear edge of the second leaf is not over the floor of the elevator when the car door is open. Both the first leaf of the car door and the second leaf of the car door can therefore move completely or partially, but at least with their rear edge, over the floor of the elevator car.

The first leaf as well as the second leaf have a front edge oriented in the closing direction and an opposite rear edge and a vertical center axis lying centrally between the edges. It is quite practical if not only the rear edge, but even the center axis of the leaves are not over the floor of the elevator when the car door is open.

At the same time, the rear edge of the first leaf when the car is open (and preferably also the rear edge of the second leaf) should remain within the rectangle defined by the car. This car construction saves space and allows a compact shaft to be provided. The corresponding elevator can therefore be used and retrofitted in places where there is no room for a conventional elevator configuration, especially one with car doors.

Although the chosen shape of the elevator car with two broad corners is very advantageous for the construction of a space-saving elevator for wheelchair users, this shape has certain disadvantages for the arrangement of important elements, including the control elements, but also the arrangement of the doors. The present invention overcomes such disadvantages.

It is expedient if control elements are arranged in the region of the first broad corner or in the region of the second broad corner. Such control elements are, in particular, the elements with which the desired floor for transportation can be input. It is particularly expedient if equivalently acting control elements are provided one above the other, namely at a first height for standing persons and at a second (lower) height for wheelchair users.

It is also expedient if the car door comprises three leaves, whereby the car door can open in two directions so that the first leaf and the second leaf have a first opening direction and the third leaf has an oppositely oriented opening direction. For example, the first leaf and the second leaf can open to the right and the right leaf can open to the left.

It is particularly favorable if the third leaf is configured to be shorter than the first leaf and the second leaf. As the third leaf cannot open towards the broad corner, it takes up less space than the first leaf and the second leaf.

It is also expedient if the car door comprises four leaves, whereby the car door can open in two directions, so that the first leaf and the second leaf have a first opening direction and the third leaf and the fourth leaf have an oppositely oriented opening direction.

An expedient elevator car can have two guide lugs, by which it can be suitably connected to guide rails. More than two guide lugs and correspondingly more than two guide rails can also be used, but it is generally sufficient in the context of the present invention for the elevator car to have two guide lugs. For this purpose, the first guide lug can be arranged in the first broad corner and the second guide lug in the second broad corner. Using the broad corners to arrange the guide lugs has the advantage that a relatively short diagonal is created for better guidance. When the term ‘guide lug’ is used here, it can generally refer to an expedient element for interacting with a guide rail, usually a mechanical element, but which can be embodied as a female element or as a male element (the guide lugs are also often simply referred to as “guides”). For example, the guide lug can be configured in the form of a groove that surrounds a guide rail. It can also be useful to use four guide lugs, especially at different heights of the car, for example two near the roof and two near the floor (i.e., in the upper or lower 10% of the car height).

It has proven to be expedient if at least the rear edge of the first leaf is moved behind the first guide lug when the car door is open. More precisely, this means that when the leaf is moved in the opening direction (i.e., against the closing direction), the rear edge of the leaf moves so far that the edge is moved beyond the projection of the guide lug on the inner side of the door. In this way, a kind of sandwich is created, i.e., the guide lug is enclosed between the car door and the elevator car, in particular the floor of the elevator car. The arrangement therefore allows the guide rails to be brought particularly close to the car and at the same time allows the remaining space to be used for moving the car doors.

With this in mind, it is also expedient if at least the first leaf of the car door has an inner side and an outer side, wherein the inner side faces the interior of the car when the car door is in the closed position and the inner side faces the first guide lug when it is in the open position. This can be provided correspondingly for the second leaf. It is therefore also favorable if the first guide lug is located between the inner side of the first leaf and the floor of the elevator car when the car door is in the open position.

This can be provided in a similar way for the second guide lug, which is arranged in the second broad corner.

The construction of the elevator car is suitable for providing several access openings. For example, a first access opening and an opposite second access opening can be provided. It is also possible to provide a first access opening and a second access opening at right angles to each other. The basic geometric arrangement of the elevator car allows access openings and corresponding car doors to be provided in four directions. In conventional elevator cars, it is usually necessary to provide substantial portions of at least one lateral wall for control elements and other devices. Since in the context of the present invention such control elements can be provided in the first broad corner or alternatively or additionally also in the second broad corner, all lateral walls of the elevator car are available for access openings and car doors.

It is also expedient for the elevator car to have two car doors, each with two leaves. It is expedient here if the slower leaves of the car doors are each adjacent to the broad corners. In this way, the space provided in the broad corners can be used for two car doors.

In the context of the present invention, it is also of interest to provide a passenger elevator with an elevator car. Preferably, the elevator car, individually or in combination, has the features already described.

This concerns a passenger elevator with an elevator car, wherein the passenger elevator has a travel shaft with a substantially rectangular base, above which four shaft walls project, which form four shaft corners, and the elevator car has four lateral walls which extend substantially parallel to the four shaft walls, wherein the elevator car is spaced from the adjacent shaft corner in the region of a first corner and the elevator car has a car door, wherein the car door is formed as a sliding door with a first leaf and a second leaf and the first leaf has a front edge oriented in the closing direction and an opposite rear edge and a vertical center axis lying centrally between the edges, and the second leaf has a front edge oriented in the closing direction and an opposite rear edge and a vertical center axis lying centrally between the edges and the first leaf moves beyond the second leaf in the closing direction, wherein the second leaf adjoins the first corner when the car door is closed, characterized in that the center axis of the first leaf projects beyond the elevator car when the car door is open.

A passenger elevator in which a first guide rail is provided in one shaft corner and a second guide rail in the opposite shaft corner is also expedient, wherein when the car door is opened, at least the rear edge of the first leaf is displaced in the regions between the first guide rail and the adjacent shaft corner.

Further features and advantages of the invention can be found in the following drawings and the associated description. In the figures and in the associated descriptions, features of the invention are described in combination. However, these features may also be included in other combinations of a subject matter according to the invention. Each disclosed feature is therefore also to be regarded as disclosed in technically meaningful combinations with other features. Some of the figures are slightly simplified and schematic.

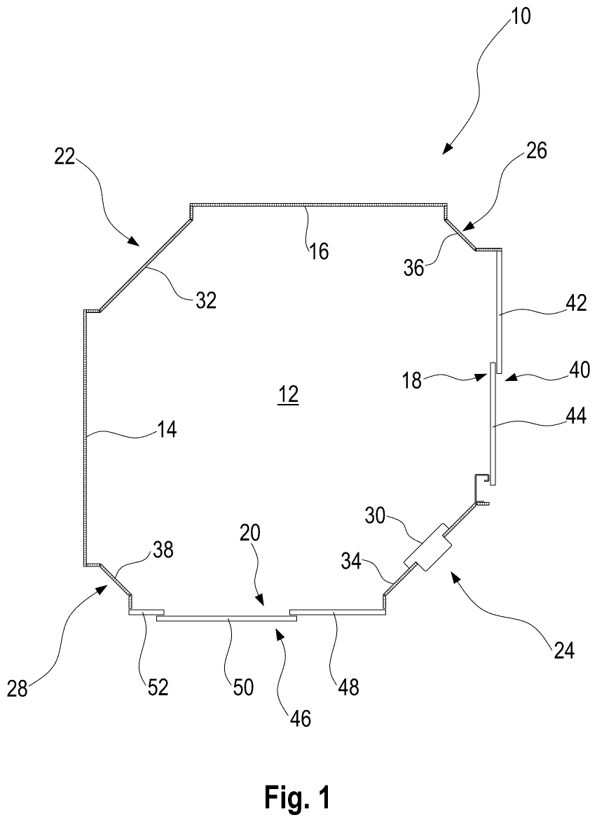

FIG. 1 shows a sectional view (plan view) of an elevator car according to the invention

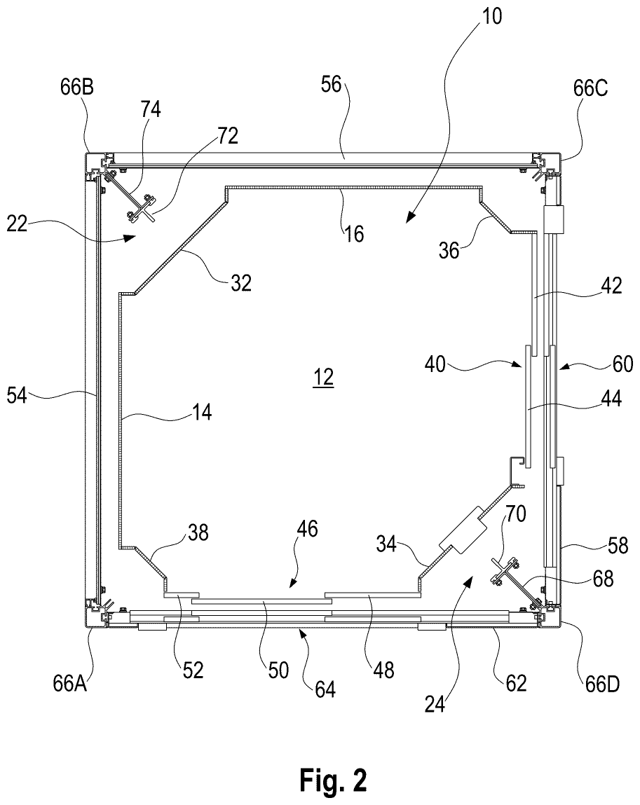

FIG. 2 shows a corresponding plan view of the car with a surrounding elevator shaft

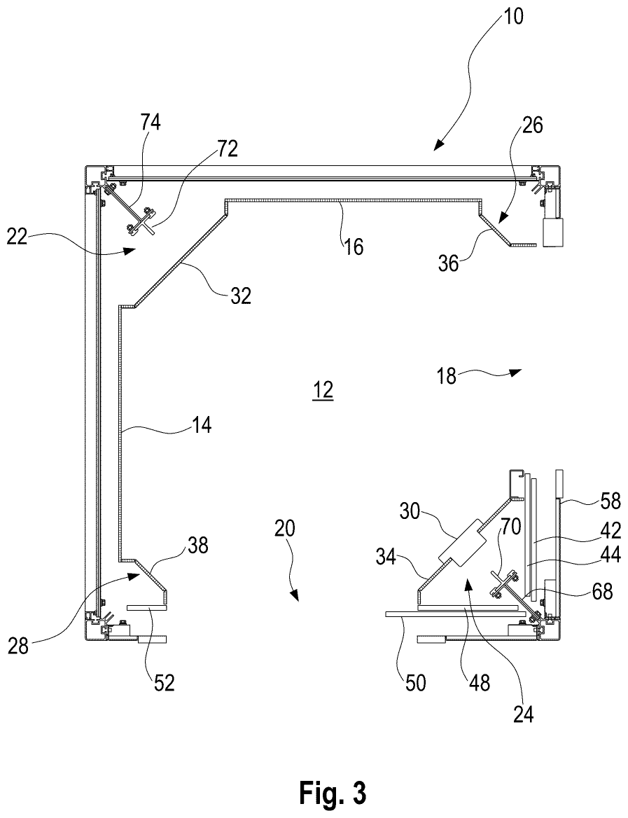

FIG. 3 shows the car in the elevator shaft with the doors open

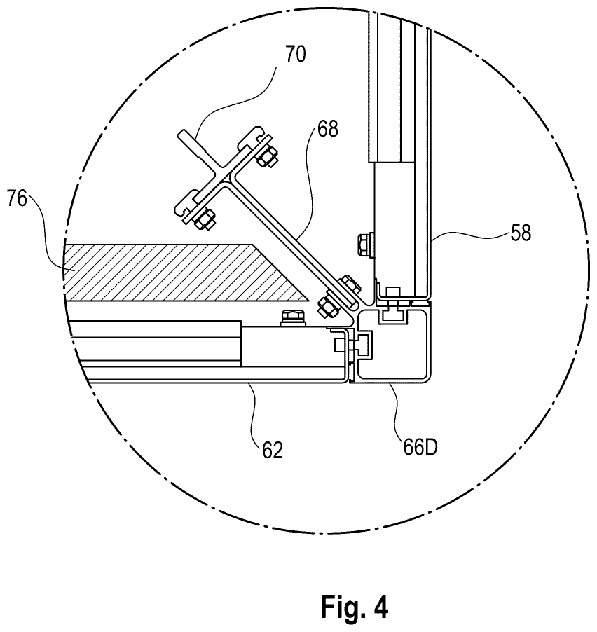

FIG. 4 shows an enlarged sectional view of a corner region of the car and the elevator shaft

FIG. 1 shows a sectional view of the car 10. It is a horizontal section, the view is from top to bottom towards the floor 12 of the car 10, so that the whole can be described as a plan view.

The car floor supports the user and possibly also a load. Unlike typical simple elevators, especially retrofitted elevators, which offer options in a small area, especially for use by wheelchair users, this car is surrounded on all sides by lateral walls or car doors. This ensures increased safety and it is also possible to achieve higher transport speeds within the framework of current safety regulations.

The floor 12 extends within a square, but is not itself square, as the corners of the square are not filled. The car 10 is delimited by a first lateral wall 14 and a second lateral wall 16. Opposite the lateral wall 14 is the first access opening 18. Opposite the second lateral wall 16 is the second access opening 20.

The lateral walls 14 and 16 run towards each other at right angles, but do not touch. Rather, a first broad corner is provided in the region where the extensions of the lateral walls would intersect. Opposite, in the region where the directions of the access openings intersect, a second broad corner 24 is provided. A first short corner 26 is provided between the lateral wall 16 and the first access opening 18. A second short corner 28 is provided between the first lateral wall 14 and the second access opening 20.

The control element 30 can be recognized as an important element of the car. Typically, two control elements are also provided, one adapted to the standing height of a user and one adapted to an appropriate operating height for a wheelchair user. A wall element 32 is provided between the first lateral wall and the second lateral wall 16. From the plan view, there is a broad corner between the lateral walls; from the interior view of the user, a further wall element 32 or panel is easily recognizable.

The broad corners are also referred to as broad corners because the wall elements in the corners that are recognizable to the user are significantly shorter than the adjacent lateral walls. For example, it is generally expedient in the context of the present invention if a wall panel that bridges a car corner has a width that is 50% or less of the width of the shorter adjacent lateral wall, for example only 40% or 30% or less.

A wall element 34 is arranged correspondingly in the second broad corner 24. This wall element can expediently support the control element 30. However, another holder, possibly independent of the wall element 34, can also be provided for the control element 30.

Wall elements are also provided in the short corners. In the first short corner 26, this is the wall element 36. In the second short corner 28, this is the wall element 38. It is expedient if the wall elements in the short corners are even less wide than the wall elements in the broad corners. For example, it is generally expedient in the context of the present invention if the width of such a wall element of a short corner is less than 80% or also less than 50% or also less than 30% of the width of a wall element of a broad corner.

The first access opening 18 is closed by a first car door 40. The first car door 40 consists of two leaves, namely the first leaf 42 and the second leaf 44. The car door is intended to open towards the second broad corner 24. This means that the first leaf 42 moves over a greater distance than the second leaf 44 when opening. The first leaf 42 is therefore usually referred to as the “fast” leaf.

The second access opening 20 is closed by the second car door 46. This car door has three leaves. The car door 46 comprises the third leaf 48 and the fourth leaf 50. It also comprises the fifth leaf 52. The leaves 48 and 50 should also open in the direction of the second broad corner 24. Thus, the fourth leaf 50 is the fast leaf here. The fifth leaf 52 opens in the opposite direction, i.e., towards the second short corner 28. The fifth leaf 52 is considerably shorter than the third leaf 48 and the fourth leaf 50.

It is generally expedient within the scope of the present invention to use a car door with three leaves, the third leaf of which is less than half as wide or even less than a third as wide as the widest of the other two leaves.

FIG. 2 shows the elevator car 10 in a view corresponding to FIG. 1, but installed in an elevator shaft. For the sake of clarity, only the essential elements of the car 10 are shown, again comprising the floor 12 and also the first car door 40 and the second car door 46.

The car 10 is surrounded by the first shaft wall 54 and the second shaft wall 56. Opposite the first shaft wall 54 is the third shaft wall 58 and the first shaft door 60. Opposite the second shaft wall 56 is the fourth shaft wall 62 and the adjacent second shaft door 64. The elevator car is suitable for shafts of various types, shown here is a shaft that was constructed with corner posts, the corner posts 66A, 66B, 66C and 66D being shown. These corner posts are arranged in the corners of a square, so that the shaft has a square base. As explained, the base 12 is nevertheless not square, but is spaced apart from the corners of the shaft in the corner regions.

There is therefore space for further devices in the shaft in the broad corners of the car 10. A first guide post 70 is provided here, which is connected to the corner post 66D by a first connecting element 68. A guide post 72 is provided opposite, which is connected to the corner post 66B by the connecting element 74. The guide posts each provide (generally within the scope of the present invention) at least one guide rail. They may consist of a guide rail alone (e.g., a flat bar) or may comprise further elements, e.g., may be formed as a T-beam. Accordingly, the guide posts are often referred to simply as guide rails. However, it is advantageous if the guide posts are self-supporting elements which at least do not require support by a shaft wall and also if the guide posts are supported on the shaft floor.

FIG. 3 shows the car with a surrounding elevator shaft from the viewing direction selected in FIG. 2. While the car in FIG. 2 is shown with the car doors closed, FIG. 3 shows the car doors open. To simplify the view, the shaft doors, which are generally also provided, have been omitted.

The first access opening 18 was opened for access by moving the leaves of the first car door, namely the first leaf 42 and the second leaf 44, towards the second broad corner 24. The first leaf 42 covers the second leaf 44. The first leaf 42 lies outwards towards the shaft wall, whereas the second leaf 44 lies inwards towards the car. As can be seen, in this opened arrangement or open position the leaves utilize the free space that arises between the car and the shaft walls (here in particular the third shaft wall 58). The leaves 42 and 44 are therefore displaced into a region behind the wall element 34. They are also displaced out of the region of the car floor 12. The leaves therefore use a region that lies outside the car, but does not extend far into the shaft.

A corresponding solution results in the region of the second access opening 20. Here, the third leaf 48 and the fourth leaf 50 are moved into the region of the second broad corner 24 so that they clear the second access opening 20. These leaves also use the free space behind the wall element 34 and are displaced so that their inner sides point towards the guide post 70.

The free space in the second broad corner 24 is used both by elements of the car and by elements of the elevator system. The elements of the car that are relevant here are the leaves of the car doors and also the control element 30. The other elements that are required for the technical operation of the elevator are the guide post 70 and the corresponding connecting element 68.

Moreover, this dual use is actually very efficient. The door leaves are moved into the free space described so that the guide post 70 is on the inner side (i.e., on the side oriented towards the car) of the door leaves.

The fifth leaf 52 of this door is moved into the region of the second short corner 28. It is now located behind the wall element 38. The free space between the car and the shaft can therefore also be used for the door leaves in the region of the sharp corners, so that these can be moved into the open position in a favorable manner and clear the second access opening as completely as possible. It would also be conceivable that not only door leaves of the car use the free space in the broad corners, but also additional equipment of the car (such as additional control elements) or the shaft. In this respect, it could be considered that further guide rods are also fitted in the region of the sharp corners or, for example, a shaft copying system with which the car height can be determined.

FIG. 4 shows an enlarged detail of the shaft structure in the region of the corner post 66D. Such a corner post can be formed as a profiled post. This allows the corresponding shaft walls, such as the third shaft wall 58 and the fourth shaft wall 62, to be well connected to the corner post 66D and to be supported by the corner posts. Corresponding wall portions can easily be made of metal, for example aluminum, plastic or even glass. They can be provided with suitable frames. Grooves can be provided for the corresponding connection. In the case of a shaft post with a substantially square profile, suitable connecting elements will therefore extend at right angles.

Additional connecting elements can be provided between these connecting elements, for example at a 45-degree angle. These additional connecting elements can be used for connection to technical components for the shaft. For example, a groove extending at a 45-degree angle is provided here (not specified) and accommodates the connecting element 68. This connecting element 68 carries the guide post 70.

This enlarged view highlights how the arrangement of corner posts and guide posts creates a region in which door leaves can be moved into the open position. This region is shown hatched as region 76.

All in all, it is possible to see how an elevator car and a corresponding passenger elevator can be constructed inexpensively and efficiently, which offers many advantages to wheelchair users.

### LIST OF REFERENCE SIGNS

10 Car
12 Floor
14 First lateral wall
16 Second lateral wall
18 First access opening
20 Second access opening
22 First broad corner
24 Second broad corner
26 First short corner
28 Second short corner
30 Control element
32 Wall element
34 Wall element
36 Wall element
38 Wall element
40 First car door
42 First leaf
44 Second leaf
46 Second car door
48 Third leaf
50 Fourth leaf
52 Fifth leaf
54 First shaft wall
56 Second shaft wall
58 Third shaft wall
60 First shaft door
62 Fourth shaft wall
64 Second shaft door
66 Corner post
68 Connecting element
70 Guide post
72 Guide post
74 Connecting element

1. An elevator car (10) for a passenger elevator, the elevator car comprising a floor (12), at least one wall element (14, 16), an access opening (18, 20) and a car door, which can close the access opening, wherein the floor (12) extends within a floor area and is delimited by a plurality of edges, such that four edges are located on the sides of a rectangle and the other edges are located within the rectangle so that the floor (12) forms at least two broad corners in the region of the other edges, namely a first broad corner (22) and a second broad corner (24), wherein the car door can be moved in the closing direction from an open position to a closed position and is in the form of a sliding door having a first leaf (42) and a second leaf (44), and the first leaf (42) has a front edge oriented in the closing direction and an opposite rear edge, and the second leaf (44) has a front edge oriented in the closing direction and an opposite rear edge, and the first leaf (42) moves beyond the second leaf (44) in the closing direction, wherein the second leaf (44) adjoins the first broad corner (22) when the car door is closed, characterized in that, when the car door is open, at least the rear edge of the first leaf (42) does not lie over the floor of the elevator car (10) but lies within the rectangle,

2. The elevator car (10) according to claim 1, in which the rear edge of the second leaf (44) also does not lie over the floor (12) of the elevator car (10) when the car door is open but lies within the rectangle.

3. The elevator car (10) according to claim 1, in which the floor (12) extends within a floor area and this is delimited by six edges such that four edges are located on the sides of a rectangle and two edges are located opposite each other bridging the corners of the rectangle and form the first broad corner (22) and the second broad corner (24).

4. The elevator car (10) according to claim 1, in which control elements (30) for the elevator car (10) are provided at a first height in the region of the first broad corner (22) or the second broad corner (24), and equivalently acting control elements (30) are provided at a second height, wherein the second height is lower than the first height.

5. The elevator car (10) according to claim 1, wherein the sliding door comprises a first leaf (42), a second leaf (44) and a third leaf (48), and the closing direction of the third leaf (48) is oriented opposite the closing direction of the first leaf (42) and the second leaf (44).

6. The elevator car (10) according to claim 1, having two guide lugs, which can each cooperate with guide rails, wherein a first guide lug is located in the first broad corner (22) and a second guide lug is located in the second broad corner (24), wherein at least the rear edge of the first leaf (42) is displaced behind the first guide lug in the opening direction when the car door is open.

7. The elevator car (10) according to claim 1, in which the first leaf (42) has an inner side and an outer side, wherein the inner side faces the car interior in the closed position of the car door and the inner side faces the first guide lug in the open position.

8. The elevator car (10) according to claim 1, wherein in the open position of the car door the first guide nose, when projected onto a horizontal plane, lies between the inner side of the first leaf and the floor (12) of the elevator car.

9. The elevator car (10) for a passenger elevator according to claim 1, the elevator car having a first access opening (18) and a first car door (40) which can close the first access opening (18), and having a second access opening (20) and a second car door (46) which can close the second access opening (20).

10. The elevator car (10) according to claim 9, wherein the first car door (40) is formed as a sliding door with a first leaf (42) and a second leaf (44) and the first leaf (42) has a front edge oriented in the closing direction and an opposite rear edge and the second leaf (44) has a front edge oriented in the closing direction and an opposite rear edge and the first leaf (42) moves beyond the second leaf (44) in the closing direction, wherein the second leaf (44) adjoins the first broad corner (22) when the car door is closed, and wherein the second car door (46) is formed as a sliding door with a third leaf (48) and a fourth leaf (50) and the third leaf (48) has a front edge oriented in the closing direction and an opposite rear edge and the fourth leaf (50) has a front edge oriented in the closing direction and an opposite rear edge and the third leaf (48) moves beyond the fourth leaf (50) in the closing direction, wherein the fourth leaf adjoins the second broad corner (24) when the car door is closed.

11. A passenger elevator with an elevator car (10), wherein the passenger elevator has a travel shaft of substantially rectangular base area, above which four shaft walls (54, 56, 48, 62) project, which form four shaft corners, and the elevator car has four lateral walls, which extend substantially parallel to the four shaft walls, wherein the elevator car (10) is spaced from the adjacent shaft corner in the region of a first corner and the elevator car has a car door, wherein the car door is formed as a sliding door with a first leaf and a second leaf and the first leaf (42) has a front edge oriented in the closing direction and an opposite rear edge and a vertical center axis lying centrally between the edges and the second leaf (44) has a front edge oriented in the closing direction and an opposite rear edge and a vertical center axis lying centrally between the edges and the first leaf (42) moves beyond the second leaf (44) in the closing direction, wherein the second leaf (44) adjoins the first broad corner (22) when the car door is closed, characterized in that the center axis of the first leaf (42) projects beyond the elevator car (10) when the car door is open.

12. The passenger elevator according to claim 11, wherein a first guide rail is provided in one shaft corner and a second guide rail is provided in the opposite shaft corner, wherein at least the rear edge of the first leaf (42) is displaced in the regions between the first guide rail and the a The elevator car (10) according to claim 1, in which the floor (12) extends within a floor area and this is delimited by six edges such that four edges are located on the sides of a rectangle and two edges are located opposite each other bridging the corners of the rectangle and form the first broad corner (22) and the second broad corner (24).

13. The elevator car (10) according to claim 2, in which control elements (30) for the elevator car (10) are provided at a first height in the region of the first broad corner (22) or the second broad corner (24) and equivalently acting control elements (30) are provided at a second height, wherein the second height is lower than the first height.

14. The elevator car (10) according to claim 2, wherein the sliding door comprises a first leaf (42), a second leaf (44) and a third leaf (48), and the closing direction of the third leaf (48) is oriented opposite the closing direction of the first leaf (42) and the second leaf (44).

15. The elevator car (10) according to claim 2, having two guide lugs, which can each cooperate with guide rails, wherein a first guide lug is located in the first broad corner (22) and a second guide lug is located in the second broad corner (24), wherein at least the rear edge of the first leaf (42) is displaced behind the first guide lug in the opening direction when the car door is open.

16. The elevator car (10) according to claim 2, in which the first leaf (42) has an inner side and an outer side, wherein the inner side faces the car interior in the closed position of the car door and the inner side faces the first guide lug in the open position.

17. The elevator car (10) according to claim 2, wherein in the open position of the car door the first guide nose, when projected onto a horizontal plane, lies between the inner side of the first leaf and the floor (12) of the elevator car.

18. The elevator car (10) for a passenger elevator according to claim 2, the elevator car having a first access opening (18) and a first car door (40) which can close the first access opening (18), and having a second access opening (20) and a second car door (46) which can close the second access opening (20).

19. The elevator car (10) according to claim 18, wherein: the first car door (40) is formed as a sliding door with a first leaf (42) and a second leaf (44); the first leaf (42) having a front edge oriented in the closing direction and an opposite rear edge; second leaf (44) having a front edge oriented in the closing direction and an opposite rear edge; the first leaf (42) moves beyond the second leaf (44) in the closing direction, wherein the second leaf (44) adjoins the first broad corner (22) when the car door is closed, and wherein the second car door (46) is formed as a sliding door with a third leaf (48) and a fourth leaf (50) and the third leaf (48) has a front edge oriented in the closing direction and an opposite rear edge and the fourth leaf (50) has a front edge oriented in the closing direction and an opposite rear edge and the third leaf (48) moves beyond the fourth leaf (50) in the closing direction, wherein the fourth leaf adjoins the second broad corner (24) when the car door is closed.

20. The elevator car (10) according to claim 3, in which control elements (30) for the elevator car (10) are provided at a first height in the region of the first broad corner (22) or the second broad corner (24), and equivalently acting control elements (30) are provided at a second height, wherein the second height is lower than the first height.
